(19) United States
(12) Patent Application Publication
(10) Pub. No.: US 2011/0217857 A1
(43) Pub. Date: Sep. 8, 2011

(54) CRADLE FOR FASTENING A TERMINAL BLOCK TO A MOUNTING FRAME AND ARRANGEMENT FOR EARTHING A TERMINAL BLOCK

(75) Inventors: Kevin James Truskett, New South Wales (AU); Bryce Lindsay Nicholls, New South Wales (AU); Simon Ellis, New South Wales (AU); Brett Hoe Slater, New South Wales (AU); Wayne Willian Dennes, New South Wales (AU); Malcolm Bruce Brear, New South Wales (AU)

(73) Assignee: ADC GmbH, Berlin (DE)

(21) Appl. No.: 13/128,999

(22) PCT Filed: Oct. 2, 2009
(86) PCT No.: PCT/EP2009/007071

§ 371 Date: May 12, 2011

(30) Foreign Application Priority Data
Nov. 12, 2008 (AU) 2008905825

(51) Int. Cl. H01R 13/648; H01R 13/60

(52) U.S. Cl. 439/95; 439/527

(57) ABSTRACT

The invention relates to a cradle (10, 50, 100) for fastening a terminal block (12) to a mounting frame (14), with the terminal block (12) in each case having two rows (16a, 16b, 22a, 22b) of insulation-displacement contacts (18) in a first section (20) and in a second section (24), comprising at least one fastener (26), in order to fasten a base element of the cradle (10, 50, 100) to the mounting frame (14), and a holder (30), in order to fasten the terminal block (12) to the base element of the cradle (10, 50, 100) such that the first or the second section (20, 24) faces the mounting frame (14), and to an arrangement for earthing components (31) which can be connected to a terminal block (12).

The invention relates to a cradle for fastening a terminal block to a mounting frame, and to an arrangement for earthing a terminal block. In particular, the invention relates to a novel and improved cradle which can be used in conjunction with terminal blocks for data transmission cables, PBX installations and corresponding telephone and data links.

So far, many types of terminal blocks have been developed, in order to allow interchangeable connections between a large number of electrically conductive lines. By way of example, the lines are in this case connected in a connection point in a building, in order to supply telephone services and other data transmission capabilities to various areas of the building.

The terminal blocks are typically used in conjunction with a cradle. In this case, lines are connected to the terminal block, and the terminal block is fitted with lines, in situ. After fitting to the terminal block, the terminal block is manually fastened in the previously installed cradle. In this case, the cradle is fitted in advance to a wall or some other vertical mounting surface.

By way of example, U.S. Pat. No. 3,931,946 discloses an integral holder for holding a terminal block via a mounting plate. Although these already known holders may be very highly suitable for their intended purposes, the cradle must be improved further, in particular for use in conjunction with modern terminal blocks which are used in PBX installations, data transmission lines and the like.

In installations for telecommunications purposes, which contain a multiplicity of vertically stacked terminal blocks, it may be difficult to connect individual lines to corresponding insulation-displacement contacts in a specific terminal block, and to disconnect them therefrom. In this case, by way of example, adjacent lines and their connection integrity may be adversely affected. These difficulties increase in particular when the terminal block contains contacts along the front face and rear face of the terminal block, in which case access to the rear faces is often blocked by a mounting frame.

By way of example, in the case of a mounting frame, the vertical rails of the mounting frame, to which the terminal block is fastened, block access to the rear face of the terminal block.

It may therefore be tedious and time-consuming to disconnect the terminal block correctly from the mounting frame in order to connect lines to the rear face of the terminal block, or to disconnect them therefrom.

The proximity of the elements of the mounting frame to the rear face of the terminal block in some cases also prevents installation of electrical components that are fitted at the rear, such as overvoltage or overcurrent protective apparatuses.

The technical problem therefore exists of providing a cradle which ensures simpler and improved connection of lines and/or electrical components to a terminal block. It is also desirable to electrically earth electrical components which are connected to the terminal block which is fastened to the cradle.

The technical problem is solved by the features of claims 1 and 11. Further preferred embodiments result from the dependent claims.

For this purpose, a cradle for fastening a terminal block to a mounting frame, with the terminal block in each case having two rows of insulation-displacement contacts in a first section and in a second section, comprises at least one fastener, in order to fasten a base element of the cradle to the mounting frame, and a holder, in order to fasten the terminal block to the base element of the cradle such that the first or the second section faces the mounting frame. In this case, the holder is preferably designed such that the second section is arranged offset in front of the mounting frame when the second section faces the mounting frame.

In this case, the first and the second section are preferably arranged on opposite sides of the terminal block. By way of example, the first section is thus arranged on a front face of the terminal block, and the second section is arranged on a rear face of the terminal block. In this case, both sections in each case have two rows of insulation-displacement contacts, with the two rows being arranged alongside one another.

The terminal block is fastened to the cradle by means of the holder. The base element of the cradle is fastened to the mounting frame by means of the at least one fastener. The mounting frame is preferably formed with round rods, with the cradle being fastened, for example, to vertical round rods of the mounting frame.

In this case, the expression the second section facing the mounting frame means that, for example, the rear face of the terminal block is oriented toward the vertical rails or round rods of the mounting frame.

Furthermore, the terminal block is fastened by the holder to the mounting frame by means of a rear face, facing the mounting frame, such that a predetermined distance is maintained between the mounting frame and the rear face. This advantageously makes it possible to provide sufficient space between the rear face and the mounting frame in order, for example, to connect electrical components to the rear face of the terminal block. The electrical components in this case comprise, for example, overvoltage or overcurrent protective devices.

In a further embodiment, the holder is designed such that the terminal block can be fastened to the cradle in a first arrangement and in a second arrangement, with the first section facing away from the mounting frame in the first arrangement, and with the second section facing away from the mounting frame in the second arrangement. For example, in the first arrangement, the rear face of the terminal block faces the mounting frame, while in the second arrangement the front face faces the mounting frame. This advantageously makes it possible to fasten the terminal block to the mounting frame by a front face or rear face which faces the mounting frame. In consequence, either the front face or the rear face of the terminal block is accessible from a front face of the mounting frame.

In order to allow such fastening, it is possible for the cradle or the holder to have holding elements, in which case connecting elements which correspond to the holding elements can be attached to the terminal block.

By way of example, the holder has C-shaped cutouts as holding elements. In this case, pins can be inserted as corresponding connecting elements into the C-shaped cutouts, with the pins being arranged on the terminal block. In the inserted and therefore fastened state, the C-shaped cutouts bracket the pins.

In a further embodiment, the holder has lateral support members or support member pairs, with the support members or support member pairs extending outward from the base element.

A support member preferably comprises an upper and a lower support member Furthermore, the holder preferably comprises a first and a second support member or support member pair, with these being arranged laterally offset. In this case, the laterally offset support members extend outward in the same direction from the base element.

In this case, by way of example, the base element of the cradle is an elongated body, at whose end, for example, a first and a second support member are arranged.

The support members, which are arranged laterally offset and extend outward from the base element, advantageously make it possible to maintain the predetermined distance between the support frame and the front face or rear face of the terminal block.

In this case, it is feasible for the holding elements to be arranged on the support members, and for the corresponding connecting elements to be arranged, for example, on side end sections of the terminal block. In particular, it is possible to arrange the corresponding connecting elements on side end sections of the second section, for example of the rear face of the terminal block.

This allows end sections of the second section of the terminal block to be fastened to the support members.

The side end sections are in this case, for example, arranged on opposite sides of the terminal block.

In a further embodiment, distal end sections of the support members have at least one cutout in order to at least partially accommodate at least one pin.

In this case, by way of example, the holding elements mentioned above, for example the C-shaped cutouts, are arranged on the distal end sections of the support members.

The corresponding connecting elements, for example the pins or pin pairs, are arranged in a corresponding manner on the side end sections of the terminal block.

In order to fasten the terminal block to the cradle, the pins or the pin pairs are inserted into the C-shaped cutouts or cutout pairs. In this case, it is possible for the cutouts to entirely or only partially bracket the inserted pins.

In a further embodiment, at least one part of a pin can be accommodated in the at least one cutout, with the cutout pressing flexibly on at least the one part of the pin. This advantageously assists mechanical coupling between the cutouts and the inserted pins.

In a further embodiment, the terminal block can be detachably connected to the holder. It is feasible, for this purpose, to be able to release the pins from the cutouts when a force which is sufficient for this purpose is exerted on the terminal block. In this case, the terminal block is preferably released from the holder when a force in the opposite direction to the mounting frame is exerted on the terminal block.

In a further embodiment, at least one terminal block can be fastened to the holder such that at least one side end section of the terminal block can be pivoted between a first and further positions with respect to the mounting frame, with the first or the second section facing the mounting frame in the first position.

In this case, it is possible for the holding elements which are arranged on the cradle or on the holder, for example the C-shaped cutouts, and/or the corresponding connecting elements, for example the pins, to define a rotation axis A1.

In one preferred embodiment, the cutouts or cutout pairs which are arranged on a first support member or support member pair, and/or the corresponding pins or pin pairs on a first side end section of the terminal block define a first rotation axis A1, and the cutouts or cutout pairs which are arranged on a second, laterally offset, support member or support member pair, and/or the corresponding pins or pin pairs on a second side end section of the terminal block define a second rotation axis A2.

When the pins on the first side end section of the terminal block are inserted into the C-shaped cutouts in the first support member, then this advantageously makes it possible for the second side end section of the terminal block to rotate about the axis A1.

When the pins on the second side end section of the terminal block are inserted into the C-shaped cutouts in the second support member, then this advantageously makes it possible for the first side end section of the terminal block to rotate about the axis A2.

In this case, the terminal block can pivot between the first and further positions.

In a first alternative, the terminal block is fastened to the holder in the first position, and the rear face of the terminal block faces the mounting frame. In the further positions, the rear face is then accessible, for example, from the front face of the mounting frame, for connection to external electrical components.

By way of example, in the first position, all of the connecting elements which are arranged on the terminal block are fastened to the holding elements, and the rear face of the terminal block in this case faces the mounting frame. By way of example, if the terminal block has two pins or pin pairs, then both pins or pin pairs are inserted into C-shaped cutouts.

In the further positions, only one connecting element, which is arranged on the terminal block, is fastened to one holding element. A first pin or a first pin pair, for example, is thus inserted into a first C-shaped cutout or a first cutout pair, while the second pin or the second pin pair is not inserted into the second C-shaped cutout. The terminal block can therefore pivot about the axis A1.

In a second alternative, the terminal block is fastened to the holder in the first position, and the front face of the terminal block faces the mounting frame. In the further positions, the front face is then accessible, for example, from the front face of the mounting frame, for connection to external electrical components.

In an alternative embodiment, the holder has a hinge element and a latching element, with the hinge element and the latching element extending outward from the base element, with the hinge element having at least one first hinge notch, and with the latching element having at least one first latching notch.

The hinge element and the latching element are in this case, for example, arranged at opposite ends of the base element. Furthermore, it is possible for the hinge element and the latching element to extend parallel to one another away from the base element in the same direction.

In this case, a first connecting element of the terminal block can be inserted into the first hinge notch.

A second connecting element of the terminal block can be inserted into the first latching notch. In this case, it is possible for the first and the second connecting element to be arranged on opposite side end sections of the terminal block, for example on opposite side end sections of the rear face.

By way of example, the connecting elements each comprise a pin or are in the form of pins. The pin can in this case be arranged between two arms of the terminal block, which are arranged on the side end sections and offset from one another.

The first connecting element, which is in the form of a pin, is, for example, coupled to the hinge element when the pin is inserted into the first hinge notch. The second connecting element, which is in the form of a pin, is in this case coupled to the latching element when the pin is inserted into the latching notch.

Furthermore, it is possible for the first hinged notch and/or the first connecting element to define a rotation axis. In this case, the terminal block can pivot about this rotation axis and therefore also with respect to the mounting frame.

Furthermore, it is possible for the hinge element to have an inner and an outer hinge notch and a slot. The slot in this case forms a connecting channel between the inner and the outer hinge notch. In this case, the first connecting element of the terminal block, for example a pin, can be moved along the connecting channel such that the first connecting element can carry out a forward-rearward movement. In this case, a forward movement denotes a movement toward the mounting frame, and a rearward movement in this case denotes a movement away from the mounting frame.

Furthermore, it is possible for the latching element to have an inner and an outer latching notch.

The first connecting element is preferably coupled in a close arrangement to the inner hinge notch and the second connecting element is coupled to the inner latching notch or, in an expanded arrangement, the first connecting element is coupled to the outer hinge notch, and the second connecting element is coupled to the outer latching notch. This advantageously makes it possible to create sufficient space in the expanded arrangement for, for example, electrical components to be connected to the rear face, between the rear face and the mounting frame.

The rear face of the terminal block in the close and expanded arrangement preferably faces the mounting frame. Alternatively, this may also in each case be the front face of the terminal block.

In a further embodiment, the cradle has electrical connecting elements. The electrical connecting elements connect the mounting frame electrically to electrical components, with the electrical components being connected, for example, to the terminal block.

In a further embodiment, the electrical connecting elements comprise a contact element for making contact with the mounting frame, and/or contact elements for making contact with earth bars.

Furthermore, the invention relates to a cradle and a terminal block, in which the terminal block can be fastened to the cradle. The cradle and/or the terminal block may in this case be designed in accordance with the above embodiments.

An arrangement for earthing of components which can be connected to a terminal block, in which case the arrangement can be fastened to one of the above-described cradles for fastening of the terminal block, or can be integrated in the cradle for the fastening, comprises a first and a second electrically conductive earth bar, and electrically conductive connecting elements, in which case the earth bars can be arranged along opposite sides of the terminal block, and in which case the connecting elements can be connected to ends of the earth bars and to electrically conductive elements of the mounting frame. This advantageously makes it possible to electrically earth electrical components which can be connected to the terminal block, via the arrangement.

In this case, it is possible for the arrangement to have, for example, connecting elements arranged in pairs, with a first connecting element of the pair being referred to as the upper connecting element, and a second connecting element of the pair being referred to as the lower connecting element.

Furthermore, it is possible for the connecting elements or the pairs of connecting elements to be arranged along the lateral offset support members or support member pairs of the holder.

In order to make contact between the connecting elements and electrically conductive elements of the mounting frame, the connecting elements comprise, for example, electrically conductive C-shaped contacts for making contact with the mounting frame. In this case, the C-shaped contacts represent the contact elements that have been mentioned of the connecting elements for making contact with the mounting frame.

The contact elements for making contact with the mounting frame are in this case arranged in a fastener for the cradle or are integrated in this fastener. The contact elements for making contact with the mounting frame make contact with elements of the mounting frame when the cradle is fastened to the mounting frame.

In order to make contact with the earth bars, the connecting elements have, for example, bifurcated contact ends. In this case, bifurcated contact ends form, for example, the already mentioned contact elements of the connecting elements for making contact with earth bars.

By way of example, corresponding end sections of the earth bars can be held in the bifurcated contact ends. The corresponding end sections of the earth bars may in this case, for example, be rounded. The bifurcated contacts are, for example, arranged alongside, under or above cutouts, where the cutouts are the holding elements for the support members for connecting elements of the terminal block.

If the terminal block is fastened to the holder as described above, or is inserted therein, then an electrical connection is made between the bifurcated contact ends and the earth bars.

It is also possible for an upper earth bar to be arranged on an upper face of the terminal block, and for a lower earth bar to be arranged on a lower face of the terminal block.

If the connecting elements of the terminal block are pins which are arranged on opposite side end sections of the terminal block, then it is possible for the earth bars to extend between these pins along the upper face and the lower face of the terminal block.

It is also possible for ends of the earth bars to have openings for holding the pins.

In a further embodiment, the earth bars have electrically conductive flanges. The flanges can in this case be inserted into electrical components, in which case the electrical components can be inserted into the terminal block. This advantageously makes it possible to earth electrical components which are connected to the terminal block.

In a further embodiment, end sections of the earth bars can be detachably connected to contact ends of the connecting elements. This advantageously makes it possible for the electrically conductive contact ends to release, for example, corresponding end sections of the earth bars when the terminal block and therefore the earth bars arranged on the terminal block are released from the holder.

In this case, it is possible, for example, for end sections of the earth bars to be held in the bifurcated contact ends, and to be removable therefrom. If, for example, the arrangement for earthing is integrated in the cradle for fastening the terminal block, or is fastened to it, then this advantageously ensures that the terminal block can be fastened to the holder and can be detached from it.

In a further embodiment, the earth bars can be pivoted about the connecting elements.

In this case, it is possible for the rounded end sections of the earth bars to allow the earth bars to rotate in the bifurcated contact ends without losing an electrical connection between the earth bars and the mounting frame. If, for example, the arrangement for earthing is integrated in the cradle for fastening of the terminal block, or is fastened to it, this therefore advantageously ensures that the terminal block can be pivoted.

Furthermore, the invention relates to a cradle and an arrangement for earthing, with at least the electrical connecting elements of the arrangement for earthing being fastened to the cradle, or being integrated in it. The cradle and/or the arrangement for earthing may in this case be designed to correspond to the above embodiments.

The invention also relates to a cradle, a terminal block and an arrangement for earthing, in which case the terminal block can be fastened to the cradle, and in which case parts of the arrangement for earthing are fastened to the holder or are integrated in it, and further parts of the arrangement for earthing are fastened to the terminal block or are integrated in it. In particular, in this case, the electrical connecting elements can be fastened to the cradle or can be integrated in it.

Furthermore, the earth bars can be fastened to the terminal block or can be integrated in it. The cradle and/or the arrangement for earthing and/or the terminal block may in this case be designed in a corresponding manner to the above embodiments.

The invention will be explained in more detail with reference to three exemplary embodiments. In the figures:

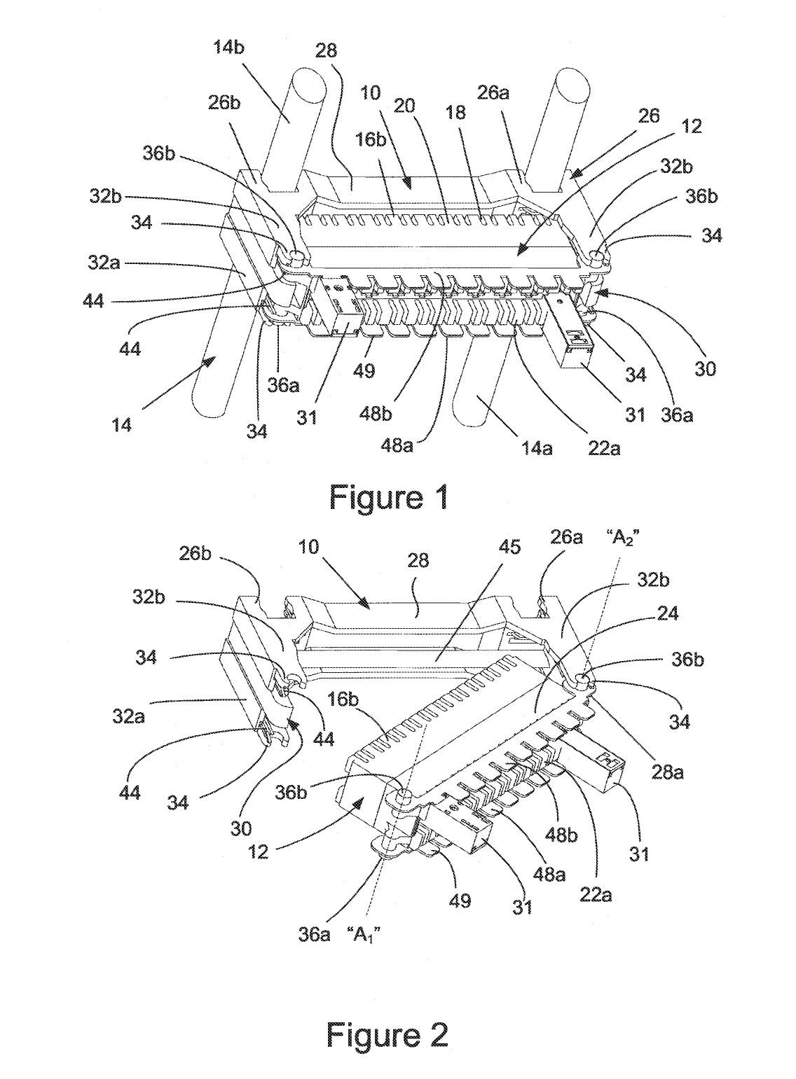

FIG. 1 shows a perspective view of a cradle, which fastens a terminal block in a first arrangement to a mounting frame,

FIG. 2 shows a perspective view of the cradle shown in FIG. 1, and a terminal block which is fastened to the cradle in a first manner

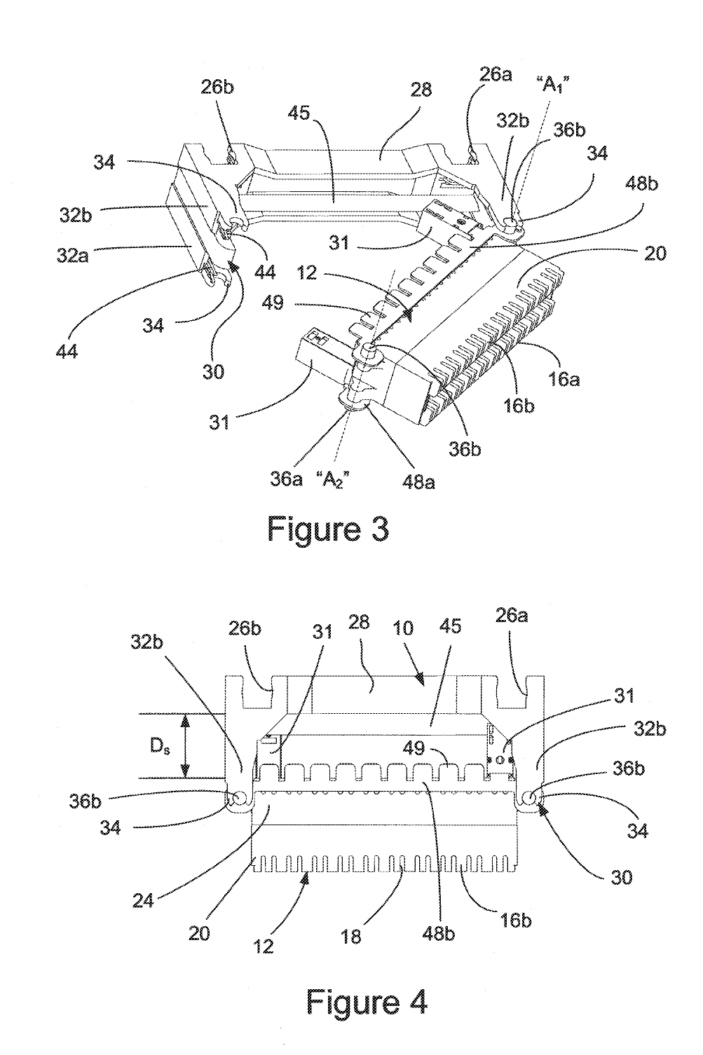

FIG. 3 shows a perspective view of the cradle shown in FIG. 1, and a terminal block which is fastened to the cradle in a first manner

FIG. 4 shows a plan view of the cradle shown in FIG. 1, and a terminal bar which is fastened to the cradle in a first arrangement,

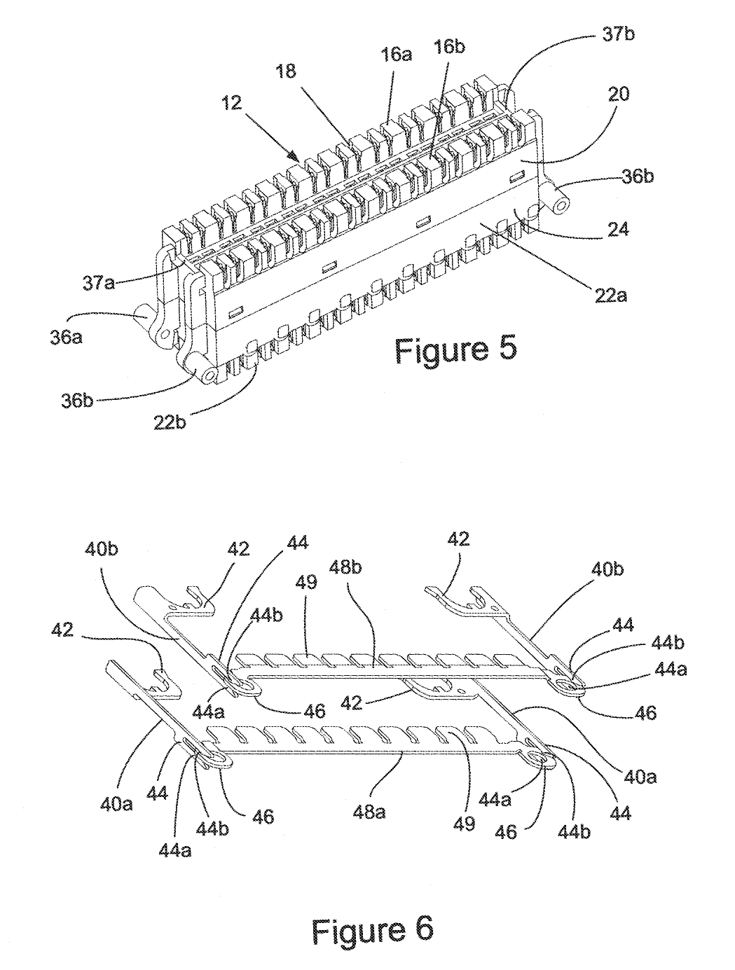

FIG. 5 shows a perspective view of a terminal block,

FIG. 6 shows a perspective view of an arrangement for earthing,

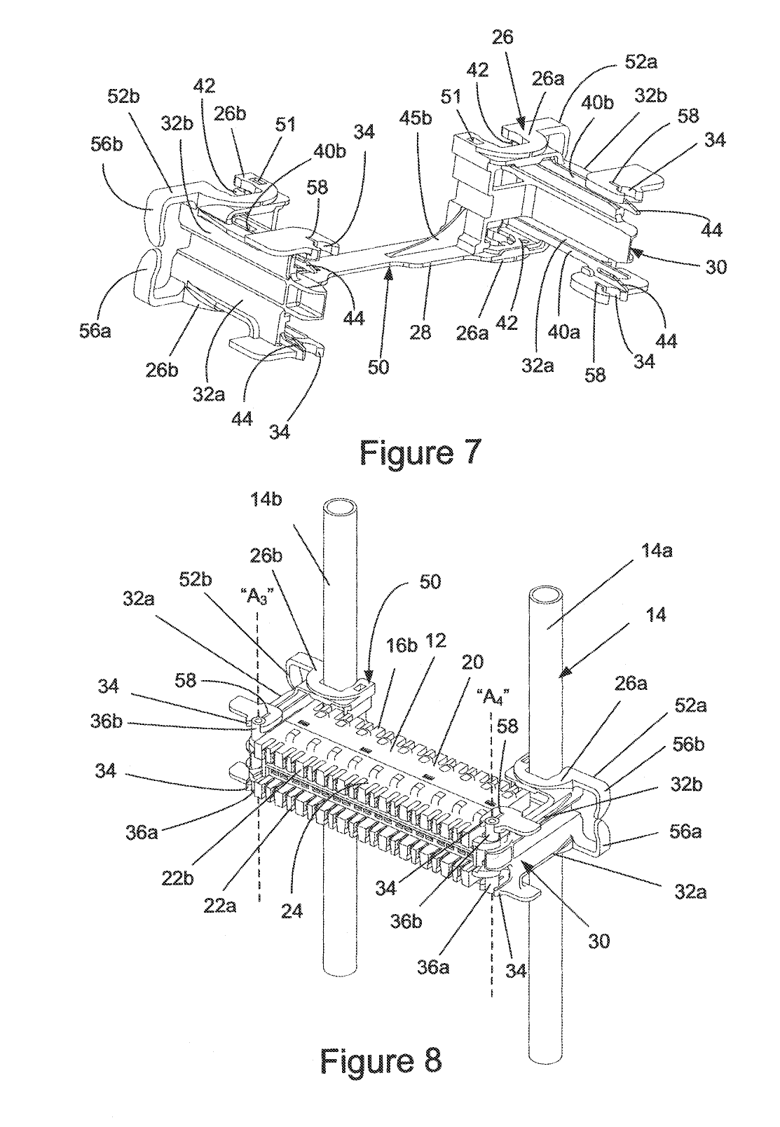

FIG. 7 shows a perspective view of a second embodiment of the cradle,

FIG. 8 shows a perspective view of the cradle shown in FIG. 7, which fastens a terminal block in a second arrangement to a mounting frame,

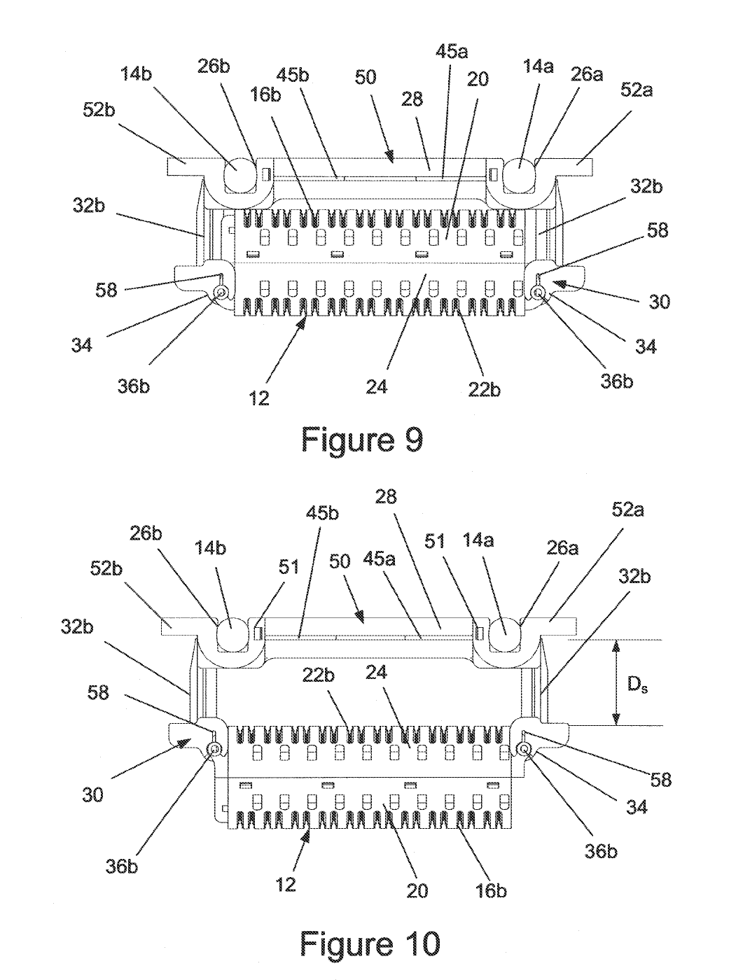

FIG. 9 shows a plan view of the cradle shown in FIG. 8,

FIG. 10 shows a plan view of the cradle shown in FIG. 7, which fastens a terminal block in a first arrangement to a mounting frame,

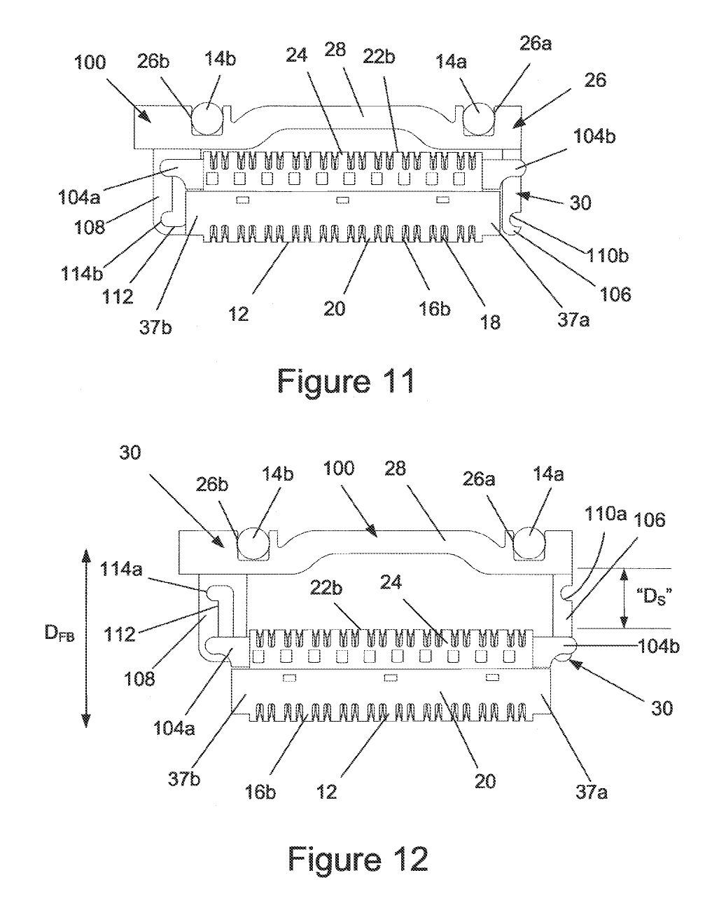

FIG. 11 shows a plan view of a third embodiment of the cradle, which fastens a terminal block in a close arrangement on a mounting frame,

FIG. 12 shows a plan view of the cradle shown in FIG. 11, which fastens a terminal block in an expanded arrangement to a mounting frame,

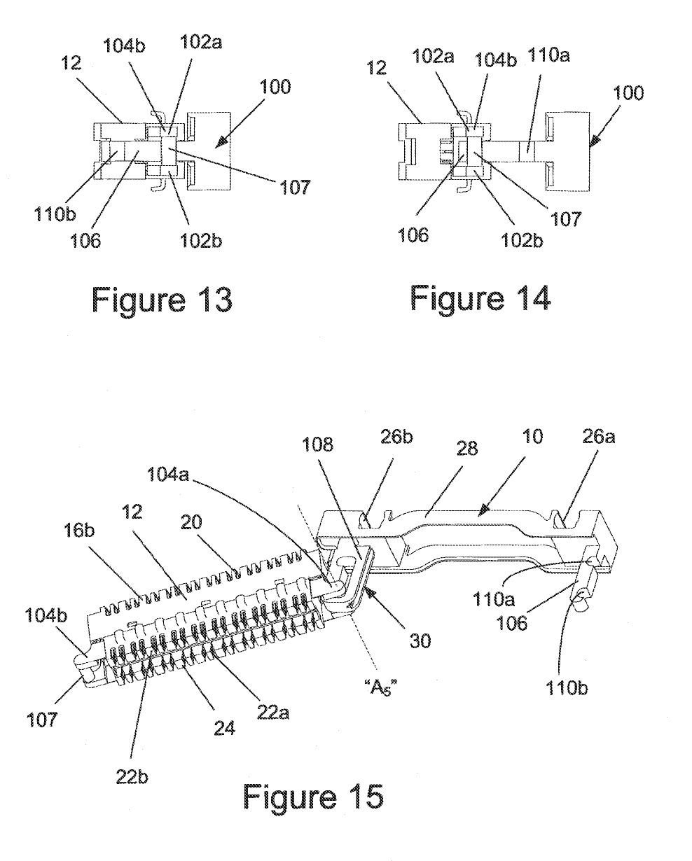

FIG. 13 shows a side view of the cradle shown in FIG. 11,

FIG. 14 shows a further side view of the cradle shown in FIG. 12, and

FIG. 15 shows a perspective view of the cradle shown in FIG. 12.

The cradle 10 shown in FIGS. 1 to 4 is used to fasten a terminal block 12 to a mounting frame 14. The mounting frame 14 is preferably a round-rod mounting frame. Alternatively, the mounting frame 14 may be any desired other suitable mounting frame, for example a rear-fitting frame. As can be seen in particular in FIG. 5, the terminal block 12 contains two rows 16a, 16b of insulation-displacement contact slots 18, which are arranged alongside one another on a front part 20 of the terminal block 12, and two rows 22a, 22b of insulation-displacement contact slots 18, which are arranged alongside one another on a rear-face part 24 of the terminal block 12. In this case, the row 22a cannot be seen in FIG. 5.

The cradle 10 comprises a fastener 26 for fastening a base element or elongated body part 28 of the cradle 10 to the mounting frame 14. The fastener 26 preferably contains a first and a second cutout 26a, 26b, with the cutouts 26a, 26b being of a suitable shape and size for gripping and fastening the cradle 10 on frame members 14a, 14b of the mounting frame 14. The cutouts 26a, 26b preferably contain further cutouts, which are not illustrated, for engaging with projecting members of a rear-fitting frame.

The cradle 10 furthermore has a holder 30 for fastening the terminal block 12 to the body part 28 of the cradle 10. In this case, the holder 30 is designed such that a rear face 24 of the terminal block 12 is opposite the mounting frame 14, in the manner shown in FIG. 4. As a result of the terminal block 12 being fastened to the holder 30, the rear face 24 of the terminal block 12 is physically separated from the mounting frame 14. The separation makes it possible to connect electrical components 31 to the rear face 24, in the illustrated manner. The electrical components 31 are preferably overvoltage and/or overcurrent protective apparatuses.

The holder 30 has two pairs of lateral support members 32a, 32b, which extend parallel in the same direction outward, away from opposite ends of the elongated body part 28 of the cradle 10. Distal end sections of the pairs of lateral support members 32a, 32b in each case have a “C”-shaped cutout 34, which are designed to engage with corresponding pin pairs 36a, 36b. The pins are in this case arranged on opposite side end sections 37a, 37b (see FIG. 5) of the terminal block 12. The terminal block 12 is fastened to the cradle 10 when the pin pairs 36a, 36b of the terminal block 12 are inserted into the respective “C”-shaped cutouts 34 in the pairs of lateral support members 32a, 32b. Since the pairs of lateral support members 32a, 32b extend away from the elongated body part 28, the terminal block 12 is physically separated from the mounting frame 14 in the inserted state.

In the inserted state, the cutouts 34 rest flexibly on the pins 36a, 36b in order in this way to mechanically couple the terminal block 12 to the cradle 10.

In this case, the coupling of the pins 36a, 36b to the cutouts 34 is detachable. This allows the terminal block 12 to be detached from the cradle 10 when a suitable force is exerted on the terminal block 12. The terminal block 12 is preferably detached from the cradle 10 when a technician pulls the terminal block 12 away from the mounting frame 14.

In the first arrangement as shown in FIG. 4, the terminal block 12 can be fastened to the cradle 10 or can be coupled to the cradle 10, with a front face 20 of the terminal block 12 facing away from the mounting frame 14. In this arrangement, the rear face 24 of the terminal block 12 is separated from the mounting frame 14 by a distance “Ds”. The distance “Ds” is sufficient to allow electrical components 31, such as overvoltage or overcurrent protective devices, to be connected to the rear face of the terminal block even when the terminal block is in the fastened state.

Furthermore, in the second arrangement as shown in FIG. 1, the terminal block 12 can be coupled to the cradle 10, with the rear face 24 of the terminal block 12 facing away from the mounting frame 14. In this arrangement, the rear face 24 of the terminal block 12 is directly accessible for connection of the terminal block 12 to electrical components 31.

The pin pairs 36a, 36b of the terminal block 12 define a respective rotation axis “A₁”, “A₂” (see FIG. 2) about which the terminal block 12 can be pivoted with respect to the mounting frame 14. By way of example, the terminal block 12 can be pivoted between a first position and a second position. In the first position, the rear face 24 of the terminal block 12 is located opposite the mounting frame 14, as shown in FIG. 4. In the second position, the rear face 24 of the terminal block 12 is accessible for external connections to the electrical components 31 from a front face of the mounting frame 14, as shown in FIG. 3.

Analogously, the terminal block 12 can be pivoted between a first position, in which the front face 20 of the terminal block 12 is now opposite the mounting frame 14 (see FIG. 1), and a second position, in which the front face 20 of the terminal block 12 is accessible for external connections to the electrical components 31 (see FIG. 2).

FIG. 6 shows an arrangement for earthing, which can be integrated in a cradle 10. The arrangement for earthing in this case comprises two pairs of upper and lower electrically conductive connecting elements 40b, 40a. Each connecting element 40a, 40b comprises an electrically conductive “C”-shaped contact element 42. The contact element 42 is in this case of a suitable size and a suitable shape in order to allow it to be arranged in a corresponding cutout 26a, 26b in the fastener 26.

The contact elements 42 engage, for example, electrically with the frame members 14a, 14b when the cradle 10 is fastened to the mounting frame 14.

Alternatively, the contact elements 42 are designed such that electrical connections can be ensured to other mounting frame systems, for example to a rear-fitting frame.

The connecting elements 40a, 40b furthermore have electrically conductive bifurcated contact ends 44. Rounded end sections 46 of electrically conductive upper and lower earth bars 48b, 48a can be held and/or fastened therein (see FIG. 6).

The electrically conductive upper and lower earth bars 48b, 48a extend along respective upper faces and lower faces of the terminal block 12 between opposite pins 36b, 36b and 36a, 36a. The end sections 46 of the upper earth bar 48b have openings. The pins 36b, 36b can be held in the openings. The end sections 46 of the lower earth bar 48a have openings in an analogous manner, in which the pins 36a, 36b can be held.

A multiplicity of electrically conductive flanges 49 are arranged on the earth bars 48a, 48b. The flanges 49 are designed such that they can be inserted into electrical components 31 which are connected to the terminal block 12. The earth bars 48a, 48b then connect the electrical components 31 electrically by means of the connecting elements 40a, 40b to the mounting frame 14.

The connecting elements 40a, 40b extend from respective cutouts 26a, 26b of the fastener 26 along the respective lateral support members 32a, 32b to the corresponding cutouts 34 in the holder 30. The bifurcated contact ends 44 of the connecting elements 40a, 40b are in this case located alongside the corresponding cutouts 34. The bifurcated contact ends 44 engage with end sections 46 of the earth bars 48a, 48b when the terminal block 12 is fastened to the cradle 10 in the manner described above.

The bifurcated contact ends 44 are in this case designed such that end sections 46 of the earth bars 48a, 48b can be held detachably in the bifurcated contact ends 44. The terminal block 12 can thus be selectively fastened to the cradle 10, and detached from it.

The rounded end sections 46 of the earth bars 48a, 48b allow the terminal block 12 to pivot in the manner described above, without interrupting the electrical connection between the earth bars 48a, 48b and the mounting frame 14. As can be seen in particular in FIG. 6, each rounded end section 46 is for this purpose mounted such that it can rotate between opposite subelements 44a, 44b of a bifurcated contact end 44. The rounded end sections 46 therefore allow unimpeded rotation of the earth bars 48a, 48b when a side end section of the terminal block 12 is pivoted away from the mounting frame 14.

The connecting elements 40a, 40b are preferably produced from an integral piece of electrically conductive material. As an alternative, the connecting elements 40a, 40b may contain a suitable combination of materials which allows the terminal block 12 to be earthed by the cradle 10.

The cradle 10 also has a rib 45 which extends between the pairs of lateral support members 36a, 36b. The rib 45 is used to reinforce the cradle 10. The rib 45 is also used for electrical isolation of printed circuit boards (PCBs) of the overvoltage protective arrangements 31 on an upper face of the terminal block 12 and of printed circuit boards (PCBs) of the overvoltage protective arrangements 31 on a lower face of the terminal block 12.

The cradle 50, which is illustrated in FIGS. 7 to 10, functions analogously to the cradle 10. Common parts of the two are annotated with the same reference symbols in the following text and in the drawings.

The cradle 50 is designed to be similar to the cradle 10. Only the differences between the cradle 50 and the cradle 10 will therefore be explained in the following text.

The cutouts 34 in the holder 30 in the cradle 50 each contain a slot 58. The openings of the “C”-shaped cutouts 34 can be spread apart flexibly by elastic deformation of the slots 58 when the corresponding pins 36a, 36b are inserted into the cutouts 34. When the pins 36a, 36b have been inserted, then the cutouts 34 rest flexibly on the pins 36a, 36b, and thus hold the terminal block 12 on the cradle 50.

The terminal block 12 is therefore fastened to the holder 50 when the pin pairs 36a, 36b of the terminal block 12 have been inserted in respective “C”-shaped cutouts 34 in the pairs of lateral support members 32a, 32b.

Analogously to the cradle 10, the terminal block 12 can be fastened to the cradle 50 in the first and the second arrangement. The fastening in the first arrangement is in this case illustrated in FIG. 10. The fastening in the second arrangement is in this case illustrated, by way of example, in FIG. 9.

Analogously to the cradle 10, the pin pairs 36a, 36b of the terminal block 12 respectively define a rotation axis “A₃”, “A₄”, about which the terminal block 12 can be pivoted with respect to the mounting frame 14. In this case, the terminal block 12 can pivot from a first position to a further position. As is shown in FIG. 10, in the first position, the rear face 24 of the terminal block 12 is opposite the mounting frame. Alternatively, it is possible for the front face 20 of the terminal block 12 to be opposite the mounting frame in the first position (see FIG. 9).

As FIG. 7 in particular shows, an arrangement for earthing is integrated in the cradle 50. The arrangement for earthing is in this case designed in a corresponding manner to the above embodiments.

The cutouts 26a, 26b in the cradle 50 each have openings 51 into which, for example, a screwdriver can be inserted, in order to assist in the removal of the “C”-shaped contact elements 42.

The elongated body part 28 of the cradle 50 has an element which extends between the cutouts 26a, 26b. The use of the element in this case enlarges the accessibility to that side of the terminal block 12 which faces the mounting frame 14. The elongated body part 28 of the cradle 50 has two support ribs 45a, 45b, which extend between the pairs of lateral support members 36a, 36b. The support ribs 45 are in this case used to reinforce the body part 28.

In this case, the cradle 50 also has a first and a second cable manager 52a, 52b, which are arranged at opposite ends of the elongated body part 28. As shown in particular in FIGS. 7 and 8, the cable managers 52a, 52b respectively have two members 56a, 56b, which are arranged at a distance from one another and extend outward parallel to one another, away from the body part 28. Mutually opposite flanges are arranged at distal ends of the members 56a, 56b, extend toward one another, and meet at a common point. The members 56a, 56b are flexible and therefore allow a cable or a multiplicity of insulated conductors to be passed through between the flanges. Furthermore, these make it possible to hold the cable in a generally fixed position with respect to the cradle 50.

The cradle 100, which is shown in FIGS. 12 to 16, functions in an analogous manner to the cradles 10, 50. Once again, the common parts of all the cradles 10, 50, 100 are annotated with the same reference symbols in the drawings.

Only the differences between the cradle 100 and the cradles 10, 50 will be explained in the following text.

Like the cradles 10, 50, the cradle 100 has a holder 30 for coupling the terminal block 12 to the body part 28 of the cradle 100. In contrast to the cradles 10, 50, the holder 30 is, however, designed such that only the rear face 24 of the terminal block 12 may be located opposite the mounting frame 14 (see FIG. 12). The holder 30 is in this case designed to physically separate the rear face 24 of the terminal block 12 from the mounting frame 14, in order to allow electrical components 31 to be connected to the rear face 24.

In the arrangement shown in FIGS. 11 to 15, the holder 30 has a latching element 106 and a hinge element 108, the two of which extend outward and parallel in the same direction away from opposite ends of the elongated body part 28 of the cradle 100. The hinge element 108 and the latching element 106 can in this case engage with a first and a second connecting element 104a, 104b, respectively. The first and the second connecting elements 104a, 104b are in this case arranged on opposite side end sections 37a, 37b of the rear face 24 of the terminal block 12. As can be seen in particular in FIG. 15, the connecting elements 104a, 104b each have a pin 107, which extends between two separated flanges 102a, 102b, with the flanges 102a, 102b projecting at the side of the terminal block 12 from a side end section 37a, 37b of the terminal block 12 (see FIGS. 13, 14).

The latching element 106 has an inner latching notch 110a and an outer latching notch 110b. In this case, the latching element 106 can be guided between the flanges 102a, 102b. In this case, it is possible for the pin 107 to latch either in the inner latching notch 110a or in the outer latching notch 110b. The second connecting element 104b is therefore coupled to the latching element 106 when the pin 107 of the second connecting element 104b is seated in one of the latching notches 110a, 110b.

As can be seen in particular in FIGS. 11 and 12, the hinge element 108 contains a slot 112 which forms a connecting channel between an inner hinge notch 114a and an outer hinge notch 114b. The pin 107 of the first connecting member 104a can slide from the front to the rear in the direction “D_{FB}”. The hinge element 108 in this case comprises the inner hinge notch 114a and the outer hinge notch 114b. The hinge notches 114a, 114b are in this case designed such that the pin 107 of the first connecting element 104a can be held in the hinge notches 114a, 114b. The first connecting member 104a is coupled to the hinge element 108 when the pin 107 of the first connecting element 104a is seated in one of the hinge notches 114a, 114b.

The pins 107 on each of the first and second connecting elements 104a, 104b are seated in a close arrangement in respective inner hinge and latching notches 110a, 114a of the latching element 106 and of the hinge element 108 (see FIGS. 11 and 13).

In an expanded arrangement, the pins 107 of the respective first and second connecting elements 104a, 104b are seated in respective outer hinge and latching notches 110b, 114b (see FIGS. 12 and 14).

This makes it possible to move the terminal block 12 from the front to the rear with respect to the mounting frame 14, between the close arrangement and the expanded arrangement in the direction “D_{FB}”. In the expanded arrangement, the rear face 24 of the terminal block 12 is separated from the body part 28 of the cradle 100 by a distance “Ds”. The distance “Ds” is sufficient to allow the connection of electrical components 31, such as overvoltage or overcurrent protective apparatuses, to the rear face 24 of the terminal block 12.

The hinge notches 114a, 114b and the pin 107 of the first connecting element 104a define two rotation axes, one of which is shown as “A5” in FIG. 15. The terminal block 12 can be pivoted about this hinge axis “A5” with respect to the mounting frame 14 between a first position and a second position. In the first position, the rear face 24 of the terminal block 12 is opposite the mounting frame 14, as shown in FIGS. 11 and 12. In the second position, the rear face 24 of the terminal block 12 is open for external connection to the electrical components 31, as shown in FIG. 15.

### LIST OF REFERENCE SYMBOLS

10 Cradle
12 Terminal block
14 Mounting frame
14a, b Frame member
16a, b Row of insulation-displacement contact slots
18 Insulation-displacement contact slots
20 Front face of the terminal block
22a, b Row of insulation-displacement contact slots
24 Rear face of the terminal block
26 Fastener
26a, b Cutout
28 Elongated body part
30 Holder
31 Electrical component
32a,b Lateral support member
34 Cutout
36a, b Pin
37a, b Side end section of the terminal block
40a, b Connecting element
42 Contact element
44 Bifurcated contact end
44a,b Subelement
45a, b Rib
46 End section of the earth bar
48a, b Earth bar
49 Flange
50 Cradle
52a, b Cable manager
56a, b Member
58 Slot
100 Cradle
102a, b Flange
104a First connecting element
104 Second connecting element
106 Latching element
107 Pin
108 Hinge element
110a Inner latching notch
110b Outer latching notch
112 Slot
114a Inner hinge notch
114b Outer hinge notch

1. A cradle for fastening a terminal block to a mounting frame, with the terminal block in each case having two rows of insulation-displacement contacts (18) in a first section (20) and in a second section, comprising:
at least one fastener, in order to fasten a base element of the cradle to the mounting frame,
a holder, in order to fasten the terminal block to the base element of the cradle such that the first or the second section faces the mounting frame.

2. The cradle as claimed in claim 1, wherein the holder is designed such that the terminal block can be fastened to the cradle in a first arrangement and in a second arrangement, with the first section facing away from the mounting frame in the first arrangement, and with the second section facing away from the mounting frame in the second arrangement.

3. The cradle as claimed in claim 1, wherein the holder has lateral support members or support member pairs, with the lateral support members or support member pairs extending outward from the base element.

4. The cradle as claimed in claim 3, wherein distal end sections of the support members have at least one cutout in order to at least partially accommodate at least one pin.

5. The cradle as claimed in claim 4, wherein at least one part of a pin can be accommodated in the at least one cutout, with the cutout pressing flexibly on at least the part of the pin.

6. The cradle as claimed claim 1, wherein the terminal block can be detachably connected to the holder.

7. The cradle as claimed in claim 1, wherein at least one terminal block can be fastened to the holder such that at least one side end section of the terminal block can be pivoted between a first and further positions with respect to the mounting frame, with the first or the second section facing the mounting frame in the first position.

8. The cradle as claimed in claim 1, wherein the holder has a hinge element and a latching element, with the hinge element and the latching element extending outward from the base element, with the hinge element having at least one first hinge notch, and with the latching element having at least one first latching notch.

9. The cradle as claimed claim 1, wherein the cradle has electrical connecting elements.

10. The cradle as claimed in claim 9, wherein the electrical connecting elements comprise a contact element for making contact with the mounting frame, and/or contact elements for making contact with earth bars.

11. An arrangement for earthing of components which can be connected to a terminal block, in which case the arrangement can be fastened to a cradle as claimed in claim 1 for fastening of the terminal block, or can be integrated in the cradle for the fastening, comprising:
a first and a second electrically conductive earth bar, and
electrically conductive connecting elements,
in which case the earth bars can be arranged along opposite sides of the terminal block, and in which case the connecting elements can be connected to ends of the earth bars and to electrically conductive elements of the mounting frame.

12. The arrangement as claimed in claim 11, wherein the earth bars have electrically conductive flanges.

13. The arrangement as claimed in claim 11, wherein end sections of the earth bars can be detachably connected to contact ends of the connecting elements.

14. The arrangement as claimed in claim 11, wherein the earth bars can be pivoted about the connecting elements.
